(19) United States
(12) Patent Application Publication
(10) Pub. No.: US 2007/0101674 A1
(43) Pub. Date: May 10, 2007

(54) Method of making a post cover and a post cover made in accordance with the method

(76) Inventor: Malcolm Stinson, Edmonton (CA)

Correspondence Address: DAVIS & BUJOLD, P.L.L.C., 112 PLEASANT STREET, CONCORD, NH, 03301, US

(21) Appl. No.: 11/541,624

(22) Filed: Sep. 29, 2006

(30) Foreign Application Priority Data
Nov. 10, 2005 (CA) 2,527,184

(51) Int. Cl. B29C 53/00; B29C 65/00; E04C 3/30

(52) U.S. Cl. 52/732.1; 156/196; 156/203; 156/304.5

(57) ABSTRACT

A method of making a post cover. A first step involves providing a rigid elongate substrate having a first face, a second face, a first side edge and a second side edge, with parallel “V” grooves positioned lengthwise in the first face and a flexible backing covering the second face. A second step involves placing glue in all but one of the “V” grooves and forming the substrate into a tube, with the flexible backing covering the one “V” groove left unglued serving as a hinge which allows the tube to open and close lengthwise around a post.

This application claims priority from Canadian Application Serial No. 2,527,184 filed Nov. 10, 2005.

### FIELD OF THE INVENTION

The present invention relates to a method of making a post cover and a post cover made in accordance with the teachings of the method.

### BACKGROUND OF THE INVENTION

U.S. Pat. No. 5,987,845 (Laronde 1999) discloses an invention relating to post covers entitled “Post cover with tongue and groove joint”.

### SUMMARY OF THE INVENTION

According to one aspect of the present invention there is provided a method of making a post cover. A first step involves providing a rigid elongate substrate having a first face, a second face, a first side edge and a second side edge, with parallel “V” grooves positioned lengthwise in the first face and a flexible backing covering the second face. A second step involves placing glue in all but one of the “V” grooves and forming the substrate into a tube, with the flexible backing covering the one “V” groove left unglued serving as a hinge which allows the tube to open and close lengthwise around a post.

According to another aspect of the present invention there is provided a post cover which includes a tubular body formed out of a rigid elongate substrate having an interior face, an exterior face, a first side edge and a second side edge. The exterior face is substantially covered by a flexible substrate. The interior face has a plurality of parallel “V” grooves positioned lengthwise, all but one of the “V” grooves being glued. The flexible backing covering the one “V” groove left unglued serves as a hinge which allows the tube to open and close lengthwise around a post.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a post cover constructed in accordance with the teachings of the present invention.

FIG. 2 is an end elevation view of the post cover illustrated in FIG. 1, in an open position.

FIG. 3 is an end elevation view of the post cover illustrated in FIG. 1, in a closed position around a post.

FIG. 4 is a top plan view of a rigid substrate used in the construction of the post cover illustrated in FIG. 1.

FIG. 5 is an end elevation view of the rigid substrate illustrated in FIG. 4.

FIG. 6 is a detailed end elevation view of the rigid substrate illustrated in FIG. 5.

### DETAILED DESCRIPTION OF THE PREFERRED EMBODIMENT

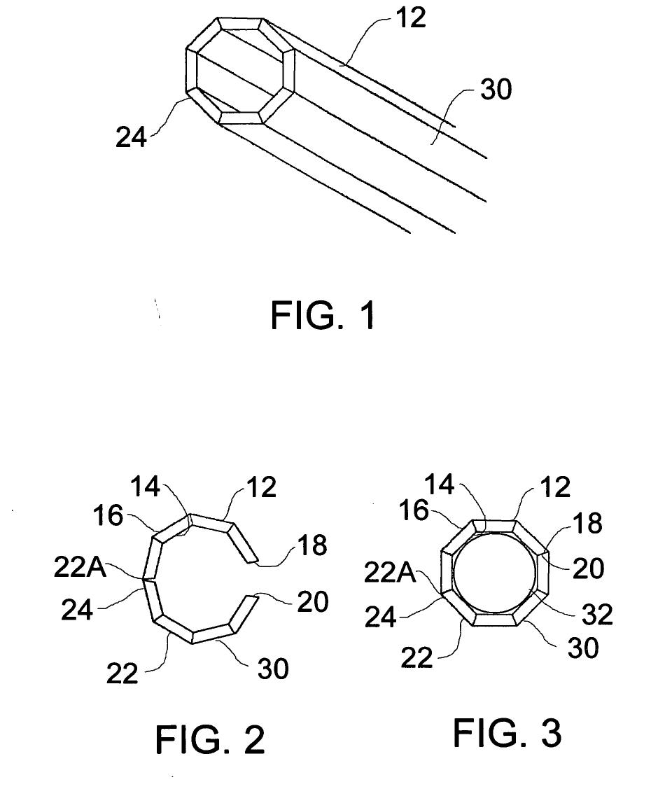

The preferred method of making a post cover will now be described with reference to FIG. 1 through 6.

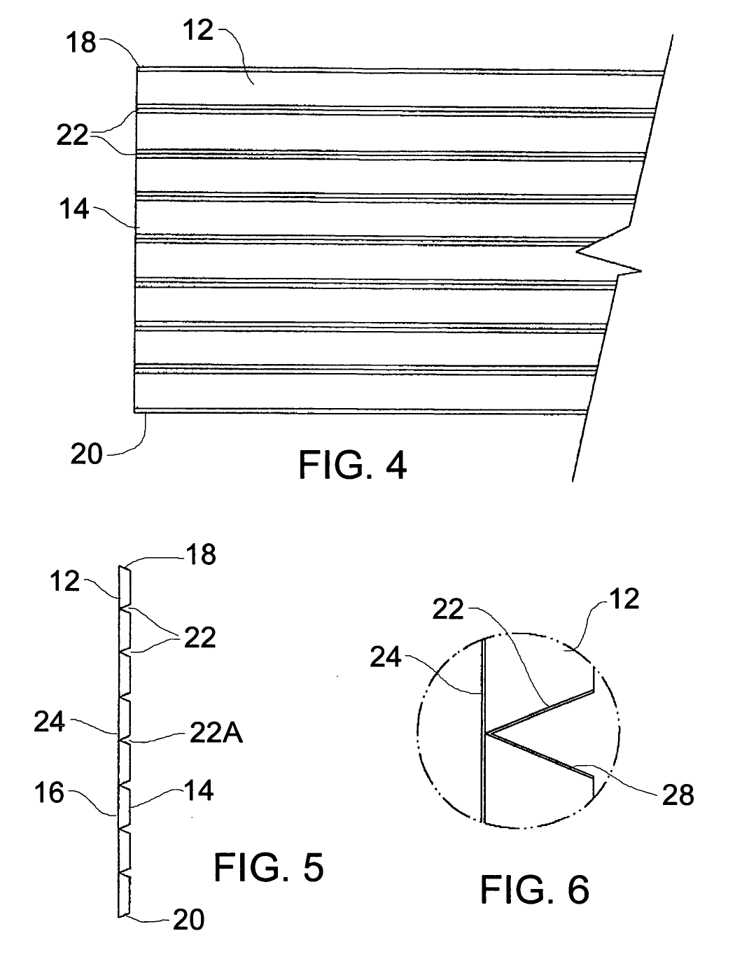

Referring now to FIG. 4, the method of making a post cover begins with the steps of providing a rigid elongate substrate 12 having, referring to FIG. 5, a first face 14, a second face 16, a first side edge 18 and a second side edge 20. Parallel “V” grooves 22 are positioned lengthwise in first face 14 and a flexible backing 24 covers second face 16. Referring to FIG. 6, glue 28 is then placed in all but one of the “V” grooves 22. Referring to FIG. 5, the unglued “V” groove is labelled 22A. Referring to FIG. 2, substrate 12 is then formed into a tube 30, with flexible backing 24 covering the one “V” groove 22A left unglued. Unglued “V” groove 22A can then serve as a hinge which allows tube 30 to open and close lengthwise around a post 32. Referring to FIG. 3, when the tube is positioned around post 32, first side edge 18 and second side edge 20 are secured together to prevent removal of post 32.

As examples, rigid substrate 12 may be made from made from drywall, MDF, plastic, or any other suitable rigid material and flexible backing 24 may be made from drywall paper, resin impregnated paper, cloth, or any other suitable material that is sufficiently strong and flexible. Also, referring to FIG. 4, rigid substrate 12 is divided into eight sections by “V” grooves 22. The angle of each groove 22 is sufficient to create a closed polygon with all surfaces touching, such that glue 28 can bond them together. It will be understood that any reasonable number of sets of “V” grooves 22 may be used, with an appropriate angle used.

Cautionary Warnings:

Care must be taken when selecting the flexible backing. The flexible backing must be strong enough to act as a hinge. When it acts as a hinge, the stress on the outside of the bend always exceeds the stress on the inside of the bend. If the flexible backing is not strong enough, it will tear. Conversely, if the backing is too thick, surface defects will appear in the form of creases or bubbles. For best results, a material that will provide strength and flexibility ought to be used, examples of which are given above.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A method of making a post cover, comprising the steps of:
providing a rigid elongate substrate having a first face, a second face, a first side edge and a second side edge, parallel “V” grooves positioned lengthwise in the first face and a flexible backing covering the second face;
placing glue in all but one of the “V” grooves and forming the substrate into a tube, with the flexible backing covering the one “V” groove left unglued serving as a hinge which allows the tube to open and close lengthwise around a post.

2. The method as defined in claim 1, including a step of positioning the tube around a post and securing the first side edge and the second side edge together to prevent removal of the post.

3. The method as defined in claim 1, the rigid substrate being drywall and the flexible backing being drywall paper.

4. The method as defined in claim 1, the rigid substrate being wooden slats.

5. The method as defined in claim 4, the flexible backing being drywall paper.

6. A post cover, comprising:
a tubular body formed out of a rigid elongate substrate having an interior face, an exterior face, a first side edge and a second side edge, the exterior face being substantially covered by a flexible substrate, the interior face having a plurality of parallel “V” grooves positioned lengthwise, all but one of the “V” grooves being glued, the flexible backing covering the one “V” groove left unglued serving as a hinge which allows the tube to open and close lengthwise around a post.

7. The post cover as defined in claim 6, wherein the rigid substrate is drywall and the flexible backing is drywall paper.

8. The post cover as defined in claim 6, wherein the rigid substrate is wooden slats.

9. The post cover as defined in claim 8, wherein the flexible backing is drywall paper.
